(19) United States
(12) Patent Application Publication
(10) Pub. No.: US 2005/0113126 A1
(43) Pub. Date: May 26, 2005

(54) Reduction of power consumption and interference power in transmit power control system

(75) Inventor: Yoshiki Wakizaka, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 10/994,685

(22) Filed: Nov. 22, 2004

(30) Foreign Application Priority Data
Nov. 26, 2003 (JP) 2003-394849

(51) Int. Cl. H04B 17/02

(52) U.S. Cl. 455/522

(57) ABSTRACT

In a transmit power control system according to the present invention, a reception level measuring unit measures a reception level based on pilot signals sent from a base station to a mobile station and a fading pitch measuring unit measures a fading pitch. A reference value control unit assigns a weight to the reception level with the fading pitch and sets an outer loop initial value of transmit power control based on the weighted reception level and information on required quality specified by the base station when an individual channel is set.

### BACKGROUND OF THE INVENTION

1. Field of the Invention

The present invention relates to a transmit power control system, mobile station and transmit power control method, and more particularly, to those used in a mobile communication system based on a CDMA (Code Division Multiple Access) mode.

2. Description of the Related Art

A transmit power control technology is indispensable for a mobile communication system based on a CDMA mode. A technology of dynamically changing a target value of transmit power control to keep communication quality constant is an outer loop. As a conventional transmit power control system, the technology disclosed in Japanese Patent Application Laid-Open No. 2000-196566 (hereinafter referred to as “Patent Document 1”) has a fixed initial value for an outer loop, and therefore a value including a certain degree of margin is set for the initial value assuming a drastically varying propagation environment.

Furthermore, Japanese Patent Application Laid-Open No. 2000-349704 (hereinafter referred to as “Patent Document 2”) discloses a technology for changing the width of transmit power control according to a transmit power control bit detection result. Furthermore, Japanese Patent Application Laid-Open No. 2001-148658. (hereinafter referred to as “Patent Document 3”) discloses a technology of changing the width of a control step according to the situation of fading which has occurred.

However, the transmit power control system according to Patent Document 1 has a fixed outer loop initial value, and therefore the initial transmit power is higher than an optimum value, involving a problem in aspects of power consumption and interference with user data of other users. Neither Patent Document 2 nor Patent Document 3 discloses means for measuring a reception level and fading pitch based on pilot signals, which is a feature of the present invention.

### SUMMARY OF THE INVENTION

It is an object of the present invention to provide a transmit power control system, mobile station and transmit power control method capable of reducing power consumption and interference power even in a drastically varying propagation environment.

In order to solve the above described problem, the transmit power control system of the present invention provides means for measuring a reception level and fading pitch and means for setting an outer loop initial value of transmit power control in consideration of the reception level weighted with the fading pitch and information on required quality specified from a base station.

This makes it possible to set an outer loop initial value at a high degree of accuracy even in a drastically varying propagation environment and thereby reduce power consumption and reduce interference power in the system.

The above and other objects, features, and advantages of the present invention will become apparent from the following description with reference to the accompanying drawings which illustrate examples of the present invention.

### BRIEF DESCRIPTION OF THE DRAWINGS

FIG. 1 illustrates the structure of a transmit power control system according to a first embodiment of the present invention;

FIG. 2 is a flow chart showing the procedure of a transmit power control method of the present invention; and

FIG. 3 illustrates the structure of a transmit power control system according to a second embodiment of the present invention.

### DESCRIPTION OF THE PREFERRED EMBODIMENTS

### 1st Embodiment

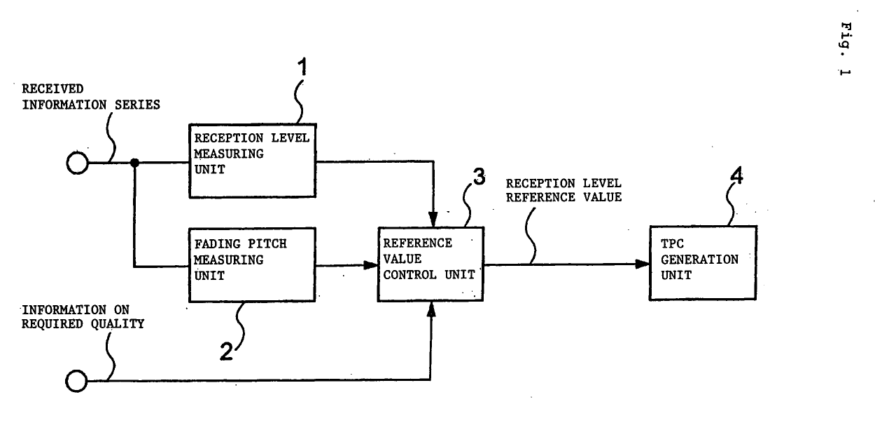

FIG. 1 shows the structure of a transmit power control system according to a first embodiment of the present invention. FIG. 1 shows the structure of a mobile station in a transmit power control system of this embodiment.

According to FIG. 1, the mobile station in the transmit power control system according to this embodiment is provided with a reception level measuring unit 1, a fading pitch measuring unit 2, a reference value control unit 3 and a TPC (Transmit Power Control information) generation unit 4. The reception level measuring unit 1 and reference value control unit 3 are connected to each other and the fading pitch measuring unit 2 and reference value control unit 3 are connected to each other. Furthermore, the reference value control unit 3 and TPC generation unit 4 are connected to each other.

The mobile station shown in FIG. 1 receives pilot signals (received information series) sent all the time from a base station which is not shown. Based on the pilot signals, the reception level measuring unit 1 measures a reception level and the fading pitch measuring unit 2 measures a fading pitch.

The reference value control unit 3 assigns a weight to the reception level measured by the reception level measuring unit 1 according to the fading pitch measured by the fading pitch measuring unit 2 and sets an outer loop initial value (reception level reference value) of transmit power control based on the weighted reception level and information on required quality. This information on required quality is the information specified from the base station when an individual channel is set.

Next, based on the outer loop initial value set by the reference value control unit 3, the TPC generation unit 4 starts generating TPC and transmit power control is thereby started.

The mobile station measures the reception level based on the pilot signals sent all the time from the base station and decides whether the cell in which the mobile station is located is sufficient for the service quality or not. Furthermore, user data such as audio data is sent using an individual channel. A mobile communication system based on a CDMA mode in particular, performs transmit power control over the individual channel.

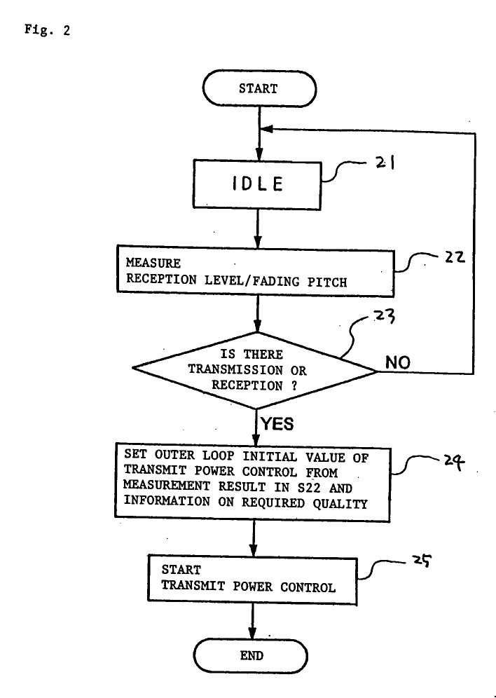

Next, the procedure of the transmit power control method of the present invention will be explained with reference to the flow chart in FIG. 2.

When an IDLE state starts in step 21, the reception level measuring unit 1 and fading pitch measuring unit 2 in the mobile station measure the reception level and fading pitch all the time based on pilot signals in step 22. When a communication using an individual channel is started for transmission or reception of user data in step 23, the reference value control unit 3 sets an outer loop initial value of transmit power control in consideration of the reception level weighted with the fading pitch and information on required quality specified from the base station in step 24. Then, in step 25, the TPC generation unit 4 starts generating TPC based on the outer loop initial value and thereby starts transmit power control. On the other hand, when there is no transmission or reception, etc., of user data in step 23, the process goes back to step 21.

As a result, in this embodiment, it is possible to set an initial value of outer loop control accurately even in a drastically varying propagation environment.

This embodiment has described that the reception level and fading pitch are measured all the time based on pilot signals (see step 22 in FIG. 2). However, the present invention is not limited to this and it is also possible to measure the reception level and fading pitch at predetermined periods.

### 2nd Embodiment

A second embodiment of the present invention differs from the first embodiment in that the reception level is weighted not at a fading pitch but according to information on the cell in which the mobile station is located (e.g., topographic information such as urban and rural areas, etc.).

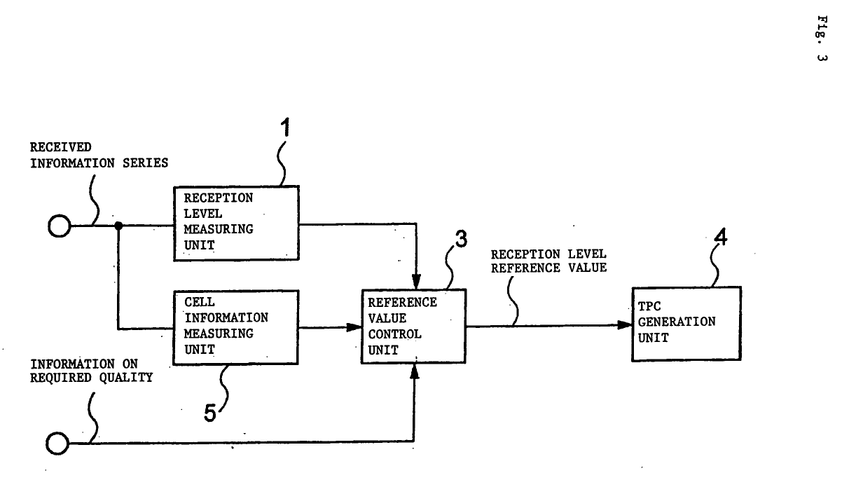

FIG. 3 shows the structure of a transmit power control system according to the second embodiment of the present invention. In FIG. 3, the same components as those in the first embodiment (see FIG. 1) are assigned the same reference numerals and explanations thereof will be omitted.

According to FIG. 3, the only difference from FIG. 1 is that the fading pitch measuring unit 2 is replaced by a cell information measuring unit 5.

That is, the cell information measuring unit 5 measures cell information included in pilot signals sent from the base station. A reference value control unit 3 assigns a weight to the reception level measured by the reception level measuring unit 1 according to the cell information measured by the cell information measuring unit 5 and sets an outer loop initial value of transmit power control based on the weighted reception level and information on required quality. Then, based on the outer loop initial value set by the reference value control unit 3, the TPC generation unit 4 starts generating TPC and transmit power control is thereby started.

For example, when the cell is in a rural area, the reference value control unit 3 assumes that a variation in the propagation environment is not drastic and reduces a margin when setting an outer loop initial value. On the other hand, when the cell is in an urban area, the reference value control unit 3 assumes that a variation in the propagation environment is drastic and increases a margin when setting the outer loop initial value.

By so doing, as in the case of the first embodiment, this embodiment can set an initial value for outer loop control accurately even in a drastically varying propagation environment.

While preferred embodiments of the present invention have been described using specific terms, such description is for illustrative purposes only, and it is to be understood that changes and variations may be made without departing from the spirit or scope of the following claims.

1. A transmit power control system provided with a base station and a mobile station which generates transmit power control information based on pilot signals sent from said base station, said mobile station comprising:
reception level measuring means for measuring a reception level based on said pilot signals;
fading pitch measuring means for measuring a fading pitch based on said pilot signals; and
reference value controlling means for setting an outer loop initial value of transmit power control based on the reception level measured by said reception level measuring means, fading pitch measured by said fading pitch measuring means and information on required quality specified from said base station when an individual channel is set.

2. The transmit power control system according to claim 1, wherein said reference value controlling means starts setting an outer loop initial value when a communication is started using the individual channel.

3. The transmit power control system according to claim 1, wherein said reception level and said fading pitch are measured at predetermined periods.

4. The transmit power control system according to claim 1, wherein said mobile station comprises cell information measuring means for measuring cell information included in said pilot signals instead of said fading pitch measuring means, and
said reference value controlling means sets an outer loop initial value of transmit power control based on the reception level measured by said reception level measuring means, cell information measured by said cell information measuring means and information on required quality specified by said base station when the individual channel is set.

5. The transmit power control system according to claim 1, wherein said transmit power control system is used for a mobile communication system based on a CDMA mode.

6. A mobile station which generates transmit power control information based on pilot signals sent from a base station, comprising:
reception level measuring means for measuring a reception level based on said pilot signals;
fading pitch measuring means for measuring a fading pitch based on said pilot signals; and
reference value controlling means for setting an outer loop initial value of transmit power control based on the reception level measured by said reception level measuring means, the fading pitch measured by said fading pitch measuring means and information on required quality specified by said base station when an individual channel is set.

7. The mobile station according to claim 6, wherein said reference value controlling means sets an outer loop initial value when a communication through the individual channel is started.

8. The mobile station according to claim 6, wherein said reception level and said fading pitch are measured at predetermined periods.

9. The mobile station according to claim 6, comprising cell information measuring means for measuring cell information included in said pilot signals instead of said fading pitch measuring means, wherein said reference value controlling means sets an outer loop initial value of transmit power control based on the reception level measured by said reception level measuring means, cell information measured by said cell information measuring means and information on required quality specified by said base station when an individual channel is set.

10. The mobile station according to claim 6, wherein said mobile station is used for a mobile communication system based on a CDMA mode.

11. A transmit power control method for generating transmit power control information at a mobile station based on pilot signals sent from a base station, comprising:
a step of measuring a reception level and fading pitch based on said pilot signals; and
when a communication through an individual channel is started, a step of setting an outer loop initial value of transmit power control in consideration of the reception level weighted with a fading pitch and information on required quality specified by said base station when the individual channel is set.

12. The transmit power control method according to claim 11, wherein said reception level and fading pitch are measured at predetermined periods.

13. The transmit power control method according to claim 11, wherein said transmit power control method is used for a mobile communication system based on a CDMA mode.
